(19) United States
(12) Patent Application Publication
(10) Pub. No.: US 2005/0053778 A1
(43) Pub. Date: Mar. 10, 2005

(54) Board product and method for the preparation of the same

(76) Inventor: Jarmo Hukkanen, Vierema (FI)

Correspondence Address: LADAS & PARRY, 26 WEST 61ST STREET, NEW YORK, NY, 10023, US

(21) Appl. No.: 10/504,161

(22) PCT Filed: Sep. 9, 2002
(86) PCT No.: PCT/FI02/00725

(30) Foreign Application Priority Data
Feb. 8, 2002 (FI) 20020264

(51) Int. Cl. B32B 21/02

(52) U.S. Cl. 428/292.4; 264/122

(57) ABSTRACT

The invention is concerned with a board product that consists of wood material, a binding agent that keeps it together and additives. The binding agent is water glass and the product furthermore contains graphite that works as a fire resistant material and as a substance, which increases the water resistance. The invention is furthermore concerned with a method of preparing a board, wherein the wood material and graphite are mixed well together. Wall paper glue is added to this mixture if such glue is used, after which the mixture is again mixed and dry water glass is added after which the mixture is again mixed. Water is added to get the desired rigidity of the mixture, with which it can be regulated and then the mixture is poured into a form and compressed to desired density.

### TECHNICAL FIELD

The invention is concerned with a board product, which consists of wood material, a cohesive binding agent, and additives. Furthermore, the invention is concerned with a method of preparation the same.

### TECHNICAL BACKGROUND

Known particle and plywood boards contain resin as binding agent, which is harmful for the environment. The problem with those is that different harmful gases, for example formaldehyde, are spread from them to the indoor air of the building.

Therefore, more environmentally friendly alternatives have been tried to develop. Water glass is an environmentally friendly substance, which is known from other connections. Its water resistance is, however, not especially good why there are given problems connected to its use. Known techniques that improve the water resistance of water glass are the additions of pigments and metal salts. Heat treatment combined with washing with acids has also been tried, as well as glyoxal treatment (Kirk Othmer (1997), vol. 22, p. 23).

### THE OBJECT TO THE INVENTION

The object of the invention is to obtain a board product, with which said disadvantages in connection with previous boards are avoided. Especially, the object of the invention is to get a board product, which is fire resistant and manufactured of pure natural materials, which do not contain substances that are harmful for humans.

### SUMMARY OF THE INVENTION

The board product of the invention consists of wood material, a cohesive binding agent and additives and it is characterized in that water glass is used as binding agent and in that the board also contains graphite as a substance that increases the fire and water resistance.

The wood material can consist of for example particles, wood chips or veneer.

The preferred embodiments of the board are presented in the dependent claims.

In the method of the invention, wood material and graphite are used, which are mixed well with each other. Wallpaper glue is added in this mixture if such glue is used after which the mixture is mixed again and water glass is added as dry material, after which the mixture is mixed again. Water is added to achieve desired rigidity, with which it can be regulated and then the mixture is poured to a form and pressed to desired density.

The compression temperature is preferably 180°-200° C. and the compression pressure is ca 32 bar, with which the desired density is achieved.

The wood material used for preparing a particle board is ca 70-90 vol.-% saw dust or chips, 3-10 vol.-% water glass as dry material, preferably 8-9 vol.-%, 2.5-14 vol.-% graphite, preferably 5.5 vol.-% and 2-6 vol.-% wall paper glue.

Graphite and water glass are non-flammable natural materials, which are harmless for humans and the nature. Furthermore, water glass hinders decay and moulding, so thanks to such a fire resistant material, other wood preservatives and mould preservatives are no more necessarily needed.

Gypsum can also be used in the invention as a fire resistant material. This at the same time increases the rigidity and strength of the board. In addition, the price of a fire resistant material containing such a substance is economic.

Also wallpaper glue can be used in the board of the invention. The wall paper glue (starch) is a water-soluble natural material, which is economic and environmentally friendly and does not contain harmful substances for humans and the nature. It also adds strength and some water resistance. A product containing wallpaper glue can also be used in veneer type products.

The particle board of the invention contains in addition to the chips as main components ca 5-15 vol.-% water glass, (if the humidity of the water glass is 53%), 2.5-14 vol.-% graphite and 2-6 vol.-% wallpaper glue and when desired, additives in accordance with the subclaims. If dry water glass is used, the amount of it is ca 2-10 vol.-%.

In tests, it has also been noticed that the water resistance of water glass can in the invention especially advantageously be improved by adding to the composition a little amount of calsium sulphate, (gypsum) or lithium carbonate or lithium chloride or titanium sulphate. In the particle board, it is also preferable to use titanium oxide (TiO₂) as a substance that increases the water resistance. The additions of salts have to be done so that the water glass is as homogenic as possible after the additions. The homogenisation can be improved by means of rigorous agitation and grinding as well as heating. Also a little particle size of the additive improves the homogenisation. Thus, the formulation, with which the board is done, can contain a little amount of additives that improve the water resistance (0.01-5%), such as lithium salts and/or lithium compounds, titanium salts and/or titanium compounds, calcium salts and/or calcium compounds and other corresponding additives.

### EXAMPLES

In the following, the invention is described by means of some example applications.

### Example 1

Particle boards were prepared at VTT (Technical Research Centre of Finland) of surface and middle-layer particles delivered by Koskinen Oy for use in the preparation of particle boards. The glue material used was according to the following formulation, a mixture of water glass (Huber Engineered Materials, sodium silicate Zeopol 33), graphite powder.(delivered by the inventor) and wallpaper glue (bought from a store):

30 dl chips=76 vol.-%

6 dl sodium silicate=15,2 vol.-%

2 dl graphite=5 vol.-%

1,5 dl wallpaper glue=3,8 vol.-%

The density and dry material content of the materials to be used in the formulation were determinated so that the substances of the glued particle mass could be calculated as absolute masses before comprimation. These are presented in table 1.

TABLE 1
Densities of used materials

| | Density | Drymaterial |
|---|---|---|
| Material | kg/cm³ | % of weight |
| Outer-layer particle | 156 | 98 |
| Middle-layer particle | 137 | 97 |
| Sodium silicate | 1380 | 38 |
| Graphite | 350 | 100 |
| Wallpaper glue | 1000 | 2 |

As the water content of the glued mass was more than 50% of weight of the dry matter content with the sodium silicate addition according to the formulation, the dry matter of the wallpaper glue (4 grams of carboxyl methyl cellulose) was added directly to the sodium silicate without preparing any water solution.

With this formulation two doses of glued mass was prepared, half of which consisted of outer-layer particles for a particle board and the other half consisted of middle-layer particles. The particles were spread out over a plywood form with a surface area of 20 cm×20 cm and with a height of 25 cm. The particles were spread out in such way that a half of the glued outer-layer particles were put first, then the middle-layer particles and onto that, the rest of the outer-layer chips. The compressed particle mats were pressed into boards in a temperature of 110° C. Overlong compression times (30 min and 90 min) were used for the boards because of the high water content and for avoiding delamination, a 15 min cooling time was furthermore performed after the compression. The boards were pressed to a thickness of 12 mm and the starting pressure of the compression was 35 bar.

The boards are marked with numbers 12 and 13 in the result table.

TABLE 2
The results of the boards made according
to the basic formulation.

| Board | Formulation | Compression | Compression | Cooling, |
|---|---|---|---|---|
| number | number | temperature ° C. | time, s | min |
| 12 | 0 | 110 | 1800 | 15 |
| 13 | 0 | 110 | 5400 | 15 |

### Example 2

In this example, the wallpaper glue was left out from the formulation and two different water glass/graphite amounts were tested in relation to the particles. With the change in the formulation, there was strived both to a decreased total amount of particles in the board and to a decreased water content to be closer to a normal level (12-13%), because it is difficult to control the compression of a board in a higher water content. It was also strived to achieve a typical board density, 680 kg/m³.

TABLE 3
Compositions of the formulations 1 and 2

| | Particles | Water glass | Graphite |
|---|---|---|---|
| | vol. -% | vol. -% | vol. -% |
| Formulation 1 | 75 | 15 | 10 |
| Formulation 2 | 85 | 9 | 6 |

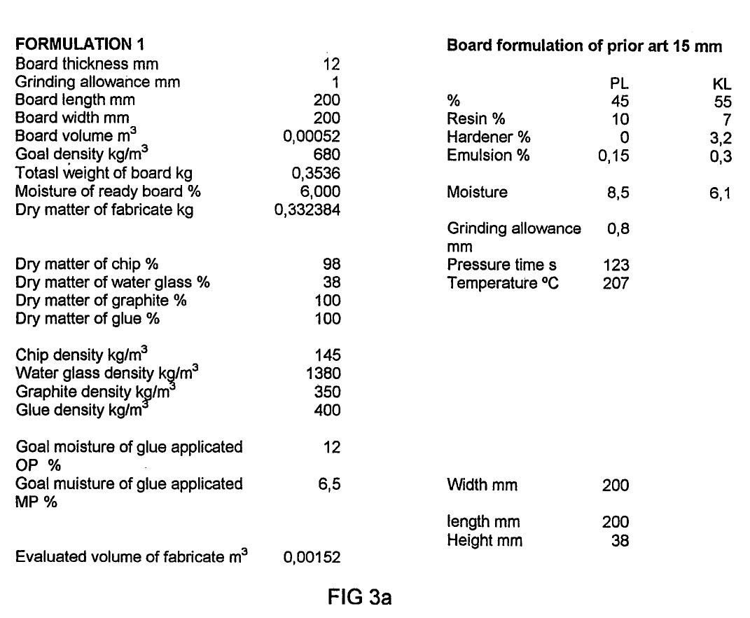

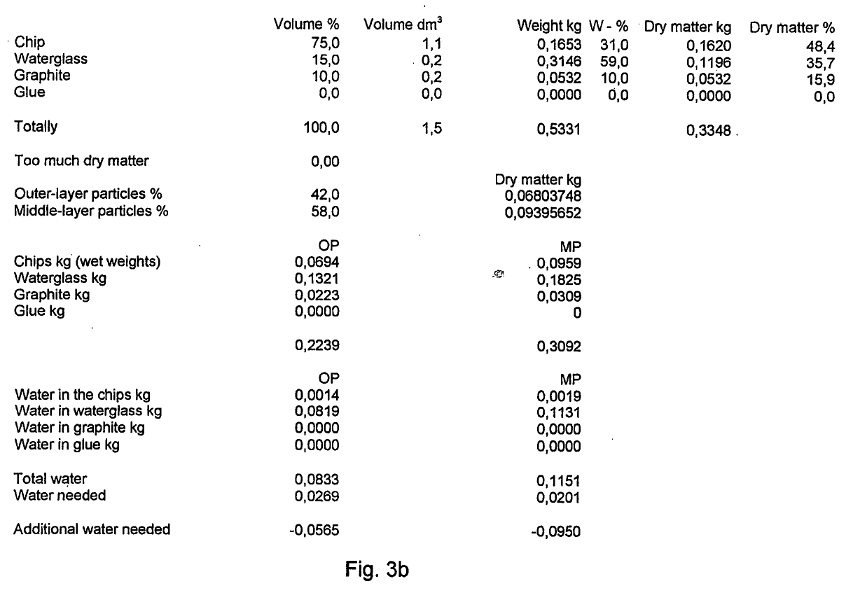

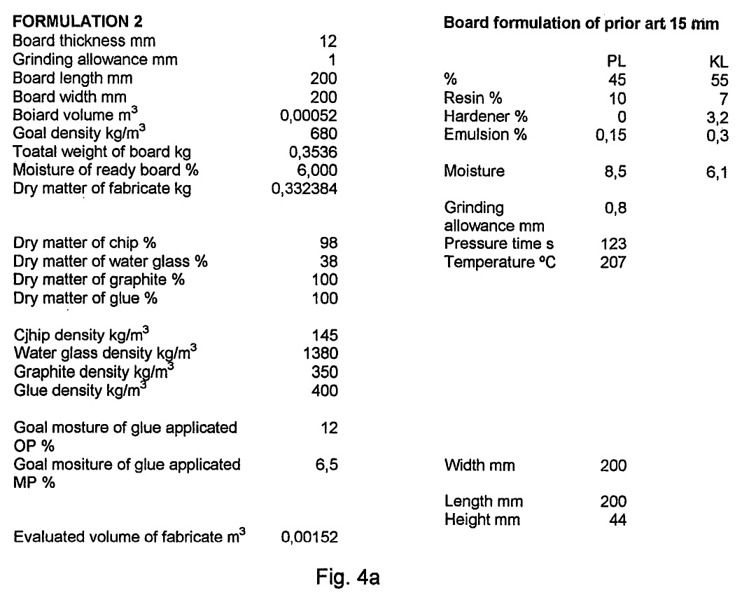

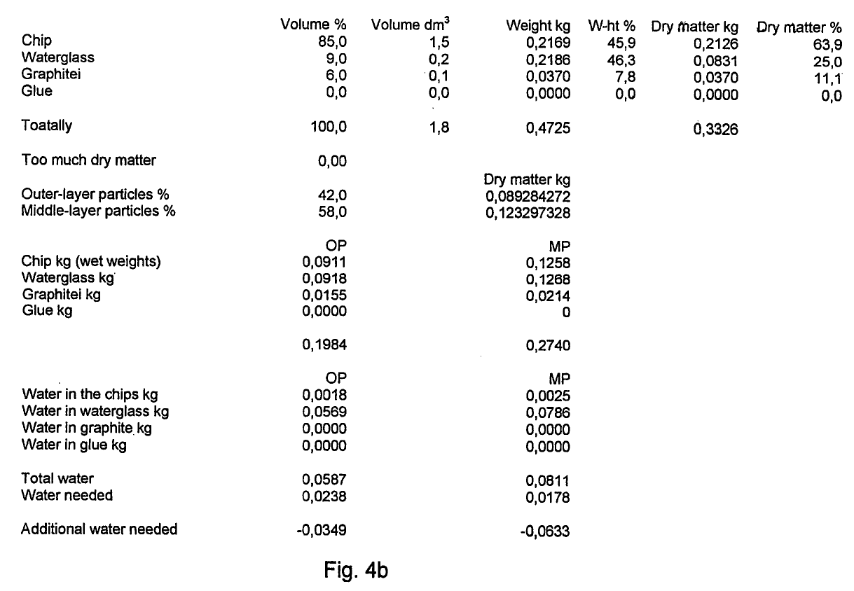

There were 42% of outer-layer particles and 58% of middle-layer particles in the particles to be glued. The whole formulations have been presented in FIGS. 3 and 4. In FIGS. 3 and 4 there have also been presented examples of board formulations of prior art.

The boards were pressed to a goal thickness of 12 mm and the calculational density was 680 kg/m³. A low density automatically decreases the IB-value. Boards 4 and 5 were close to the goal thickness and also the best IB-results were achieved with board numbers 4 and 5, which were pressed in 80° C. and which had a cooling step of 10 minutes and which had been made with formulations 1 and 2.

In the basic formulation, the relation between the graphite and the particles (formulations 4 and 5) was still changed and the test was repeated with the conditions of board number 5 (best IB).

In addition, the water resistance of the boards was tried to improve by using as additive, in formulation 4, 1% Ti02 and Li2C03 of weight of water glass. The additive in formulation 6 was Kemira's by-product gypsum (CaSO4). All these substances improved the water resistance of the board.

TABLE 5
The compositions of formulations 4, 5 and 6

| | Particles | Water glass | |
|---|---|---|---|
| | vol. -% | vol. -% | Graphite vol. -% |
| Formulation 4 | 90 | 6 | 4 |
| Formulation 5 | 80 | 12 | 8 |
| Formulation 6 | 77 | 15 | 5(+gypsum 3 vol. -%) |

A high temperature improves the water resistance of water glass, why a separate heat treatment was tried for one of the samples. A new test piece was taken from the earlier prepared test board 5, which was kept in 200° C. in an oven for one hour. The swelling was tested from the test piece after the heat treatment. The swelling was only 4.6%.

TABLE 7
Preparation of compressed boards

| Board | Formulation | Compression | Compression | Cooling, |
|---|---|---|---|---|
| number | number | temperature ° C. | time, s | min |
| 5 | 2 | 80 | 20 | 10 |
| 5 | 2 | 80 | 20 | 10 (+heating |
| | | | | 1 h, 200° C.) |

According to the results, the heat treatment improved the swelling result of a board that earlier did not stand water so that the swelling after the heat treatment was only 4.6%. This result has to be considered to be very good. Such a conclusion should either not be drawn from the results that the heating would affect the IB-value in a bad manner as the heat treatments were taken from the edges of a 23 cm×23 cm board. (The best samples with respect to a strength testing are in the middle of the board and had already been used earlier.)

Studying Results

The following conclusions can be drawn from the composition and the test results of those:
The swelling and IB (13% and 0.52 Mpa ) of a board made with the two first formulations were close to the goal even without a separate heat treatment
The swelling can be considerably improved with the heat treatment (200° C., 1 h)

### Preparation Example 2

Particle boards were prepared according to the following formulation:

30 dl particles=82.2 vol.-%

4 dl sodium silicate=11 vol.-%

1 dl graphite=2.7 vol.-%

1.5 dl wallpaper glue=4.1 vol.-%

The mixture was thoroughly mixed for ca ten minutes until a composition with a solid and uniform mass was obtained and from which a cohesive board could be prepared.

The mass was then placed in a form for preparation of a board. Baking paper was placed at the upper and lower surfaces of the board to avoid adhesion and the mass was compressed by pressing. The form was thereafter placed in an electric oven for 15 minutes in a temperature of 200° C. Thereafter, it was taken out from the oven and dried to a final dryness. The board hardened and the result was a cohesive board.

### Preparation Example 3

Particle boards were prepared according to the following formulation:

30 dl cutter chips=83,3 vol.-%

2 dl graphite=5,5 vol.-%

3 dl dry matter water glass (=sodium silicate)=8,3 vol.-%

1 dl wallpaper glue=2,8 vol.-%

The dry-materials are first mixed together. It is important that the cutter chips and the graphite are mixed well and that the graphite does not stay at the bottom of the vessel. Then the wallpaper glue is added and mixing is performed again. The water glass dry matter is added next, and mixing is performed again. Water is added last, with which the rigidity of the mixture can be regulated. The mixture is poured in a form in which it is compressed to the desired density. Baking paper has to be put between the press jaws or the like so that the mass would not fasten to the jaws. The compression temperature has to be 180-200° C. so that the dry water glass would melt.

This composition was found to be the best one in view of the final board. The board was not too moist and it was very cohesive. Its fire resistance properties are the same as those of boards 4 and 5, as the compound amounts correspond to each other.

### Preparation Example 4

30 dl cutter chips=76.9 vol.-%

2 dl graphite=5.1 vol. %

1 dl gypsum=2.6 vol.-%

6 dl water glass=15.4 vol.-%

Result: Stands in water without being destroyed. If the amount of gypsum is increased with 50% the board is not cohesive at all.

### Comparison Example 1

30 dl cutter chips

180 g (=3 dl) graphite

200 g (=1,5 dl) blast furnace

1 l water glass=22.5 vol.-%

Result: too moist, too much water glass.

### Comparison Example 2

30 di cutter chips

2 dl graphite

1 dl wallpaper glue

6 dl water glass (=15,4 vol-%)

Result: a little better water resistance, but not really good.

### Comparison Example 3

A particle board was prepared from the following composition in the same way. Particle boards were prepared with the following formulation:

30 dl cutter chips=76,9 vol.-%

7 dl sodium silicate=18 vol.-%

2 dl graphite=5,1 vol.-%

The board hardened but stayed moist. There is too much water glass, in other words sodium silicate, in this board.

Fire Resistance Test

The fire resistance tests were performed at VTT Building and Transport department with particle board samples, done with formulations 4 and 5 (see example 2 above).

During the period 3.7.2002-5.8.2002, the samples were kept in a space with a temperature of 23° C. and the relative humidity was 50%. According to the follow-up of the weight of the samples, the samples reached a constant humidity during the conditioning.

The fire resistance properties of the samples were studied 5.8.2002 by using a calorimeter according to standard ISO 5660.

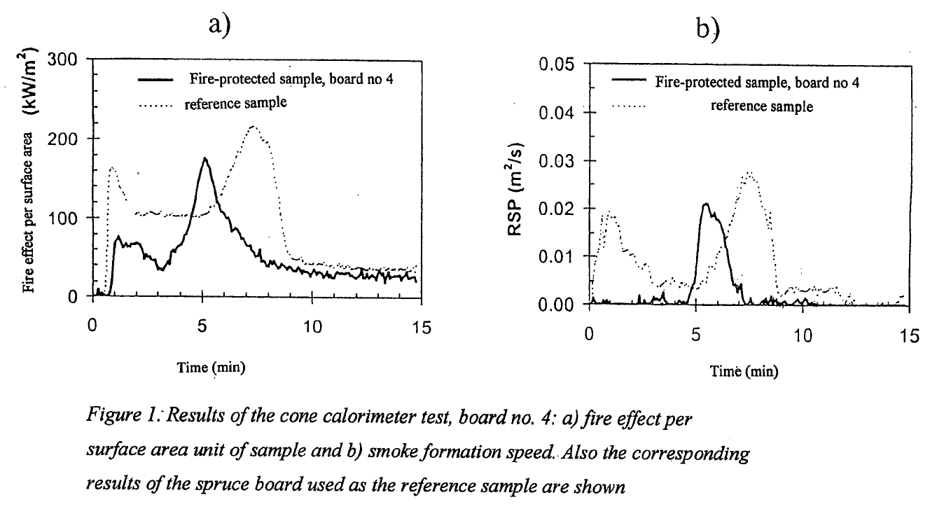

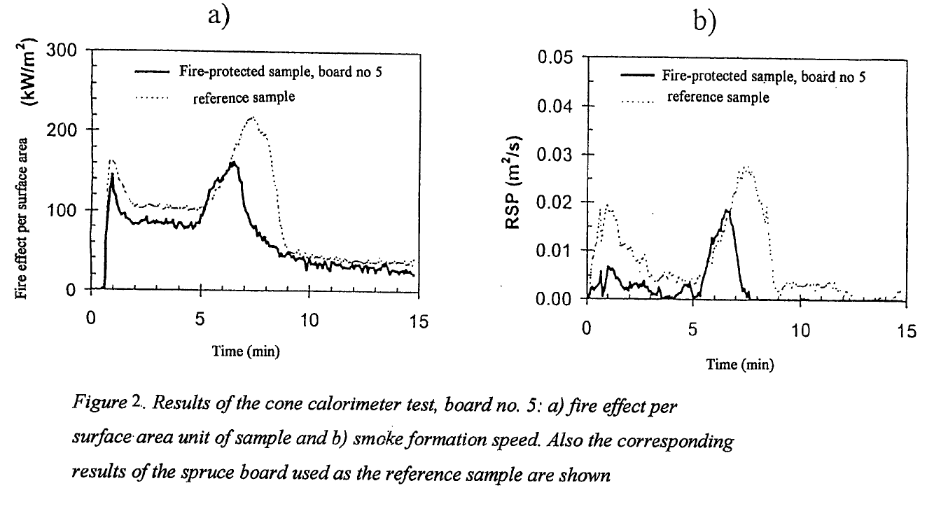

The results of the test in view of heat development and smoke formation of the sample have been presented for board 4 and board 5 in FIG. 2. The characteristics describing the test results are the following:
1) The fire effect per surface area of the sample (kW/m²), which describes how strongly the sample develops heat when burning, in other words the strength of the burning of the sample.
2) The smoke formation speed (RSP, m²/s), that describes how much smoke the sample forms during the test.

The heat development of board 4 is in the beginning of the test clearly lower than the heat development of a corresponding wood sample without any fire protection. From this it can concluded that the sample would be classified quite well in a classification test. The fire technical behavioring of building tools according to classification [1] concerning the heat development would probably be B, when it would be D with the reference sample.

The heat development of board 5 is in the beginning of the test a little lower than the heat development of a corresponding wood sample without any fire protection used as reference sample. From this it can be concluded that the sample wood be classified in the same way as the reference sample. Thus, the fire technical behaviouring of building tools in accordance with the heat development of classification [1] would probably be D.

On the basis of the results, the heat development of board 4 is better than that of board 5.

According to the results, the smoke formation speed of boards 4 and 5 does not deviate so much with respect of classification from the smoke formation speed of the reference sample.

[1]=Collection of building Rules in Finland, part El: Fire safety of building Rules and instructions 2002, Helsinki: Ministry of Environment 2002 40 p. (The degree of the Ministry of environment government of the fire safety of buildings given 12.3.2002.)

The invention is not restricted to the above advantage applications, but it can vary in scope of the invented idea formed by the patent claims.

1. Board product, which consists of wood material, a binding agent that keeps it together, and additives, characterized in that the binding agent is water glass and in that the product furthermore contains graphite, which works as a fire resistant material and as a substance that increases the water resistance.

2. Board of claim 1, characterized in that it is a particle board or a plywood type board.

3. Board of claim 1, characterized in that the board furthermore contains gypsum, which works as a water resistance giving substance.

4. Board of claim 1, characterized in that the board contains a little amount (0.01-5%) of additives, which improve the water resistance, such as lithium salts and/or such compounds, titanium salts and/or such compounds, calsium salts and/or such compounds or other corresponding additives.

5. Board of claim 1, characterized in that the wall paper glue is used as a binding agent to increase the strength.

6. Board of claim 1, characterized in that it contains 5-16 vol.-% water glass, preferably 15 vol.-% with a humidity of 53%.

7. Board of claim 1, characterized in that it contains 3-10 vol.-% dry matter water glass, preferably 8-9 vol.-%

8. Board of claim 1, characterized in that it contains 2.5-14 vol.-% graphite, preferably 5,5 vol.-%

9. Board of claim 1, characterized in that it contains 2-6 vol.-% wall paper glue.

10. Method of preparing a board that consists of wood material, a binding agent that keeps it together and additives, characterized in that in its steps ‘a) wood material and graphite are used, which are mixed well together,
b) wallpaper glue is added to the mixture of step a), after which the mixture is again mixed, and
c) water glass as dry matter is added, after which the mixture is again mixed, and
d) water is added to desired rigidity, e) the mixture is poured into a form, and compression to desired density is performed.

11. Method of claim 10, characterised in that the compression temperature is 180-200° C.

12. Method of claim 10, characterised in that the wood material used is cutter chips or chips for preparing a particle board.

13. Method of claim 10, characterised in that 70-90 vol.-% wood material, 3-10 vol.-% dry water glass, preferably 8-9vol.-%, 2.5-14vol.-% graphite, preferably 5.5vol.-% and 2-6 vol.-% wallpaper glue are used in the preparation of the mixture.
